(19) United States
(12) Patent Application Publication
(10) Pub. No.: US 2021/0051947 A1
(43) Pub. Date: Feb. 25, 2021

(54) HUNTING BLIND

(71) Applicant: Larry D. Greer, LaFayette, TN (US)

(72) Inventor: Larry D. Greer, LaFayette, TN (US)

(21) Appl. No.: 16/550,199

(22) Filed: Aug. 24, 2019

(51) Int. Cl. A01M 31/02; B60P 3/32; E04H 1/12; E04H 15/00

(52) U.S. Cl. CPC A01M 31/025; B60P 3/32; B62D 63/062; E04H 15/001; E04H 1/1205

(57) ABSTRACT

An illustrated view of an exemplary hunting blind is presented. The hunting blind is useful for those that may need help in putting the hunting blind in an ideal location of a tree. The hunting blind is also useful to allow a hunter, in the hunting blind, to remain in the hunting blind when accessories are needed. The hunter would not leave the hunting blind which may scare away to game the hunter is hoping to hunt. The hunting blind is preferably seven (7) feet in height. The hunting blind has a winch and cable to hoist or raise the hunting blind into a tree. The winch is powered by a 12-volt battery and has a switch to automate the raising of the hunting blind. Other amenities are also provided such as a toilet, a seat, a cooler, a heater/cooker, charger for computing devices and a light.

### FIELD OF THE INVENTION

This invention relates to hunting blinds. More particularly, it relates to hunting blinds with additional facilities.

### BACKGROUND

A hunting blind (US), hide or machan is a cover device for hunters or gamekeepers, designed to reduce the chance of detection. There are different types of blinds for different situations, such as deer blinds and duck blinds. Some are exceedingly simple, while others are complex. The legality of various kinds of blinds may vary according to season, state and location.

Blinds may be stable or mobile. An early blind used by hunters was a cocking-cloth, a piece of canvas stretched on a frame like a kite that would permit hunters to approach pheasants and to shoot them through a hole in the cloth.

Ground blinds are an alternative to the traditional tree stand; movements in a well-designed ground blind can virtually be undetectable by the game.

Duck blinds in the grain fields in south central Oregon and north central California can be as simple as a hunter walking two or three miles out into a grain field, stopping at a dike, a raised area, two feet (60 cm) or so high, 10 or 12 feet (3.0-3.6 m) wide and usually a half mile or so long on a side. The hunter simply sits down on the top and pushes dirt away with both feet, front and back. In two to three minutes a shallow depression is created. Then additional stubble from cut grain can be placed around the edges, enough to provide cover when the hunter lies down when birds are spotted, sitting up when they come in range.

The blind can be deepened to allow sitting upright, if desired, by using a digging tool. In other areas duck blinds can be quite elaborate. More substantial structures are common in the midwestern United States, and their purpose often extends beyond concealment to include protection from the elements, particularly from rain and cold. In some areas, blinds can approach small cabins in their size and amenities. A sink-box is another elaborate form of duck blind, designed for partial submersion in a body of water; sink-boxes are illegal to use in the United States. Also, for hunting waterfowl in fields, hunters will use a layout blind. A layout blind is a low-profile blind that a person can lay down in and stubble in to hide from waterfowl.

Deer blinds may not be legal in all areas, so hunters are obligated to check hunting laws before constructing them. Alternatives include simply sitting still at the base of a tree. It may be illegal is adding to a natural condition to improve upon it and conceal a hunter's presence, or actually constructing something with sides and a roof. In some states, hunting from a camouflaged blind may be prohibited during rifle/shotgun season. In such cases, a hunter is required to add orange patch on blind such that the orange is visible from all angles.

Other simple blinds include climbing a tree, usually with special climbing equipment and with some kind of seat, or with a burlap enclosed frame.

Hunting blinds are basic structures without the creature comforts of home. Hunters spend long days and sometimes nights in the hunting blind and need accessories of home in the hunting blind. Therefore, there is need for a hunting blind with at least some of the comforts of home built in or can be added to an existing hunting blind. There is also a need for a hunting blind that can be lifted, with minimal effort of a hunter, into a tree.

### BRIEF DESCRIPTION OF THE DRAWINGS

FIG. 1A is an illustrated view of an exemplary hunting blind.

FIG. 1B is an illustrated view of an exemplary pistol/crossbow used in concert with the exemplary hunting blind shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

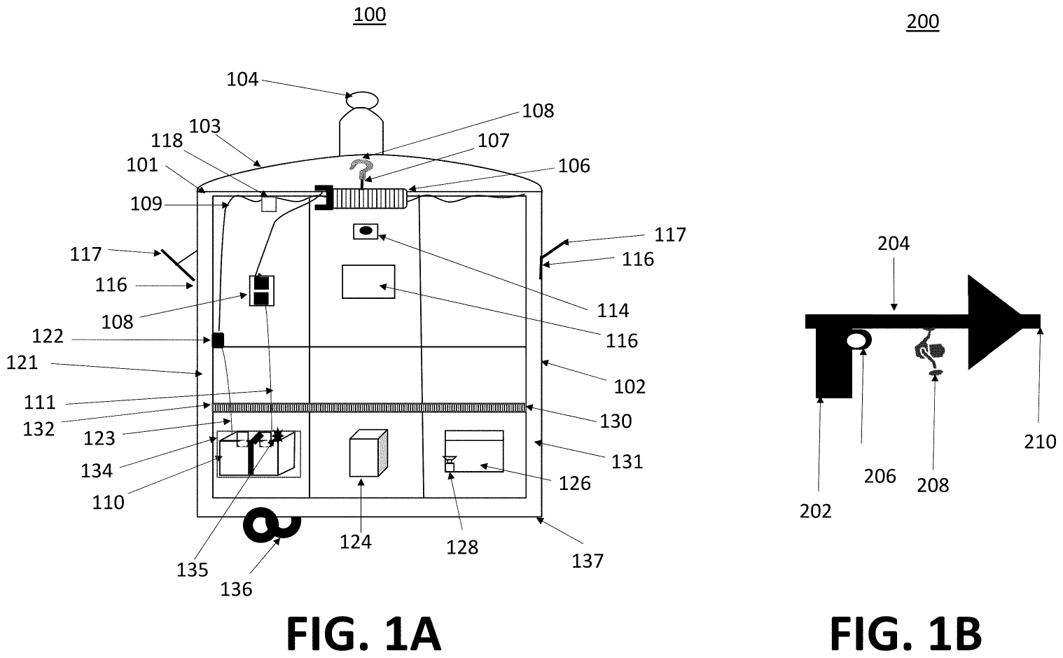

Referring to FIG. 1, an illustrated view of an exemplary hunting blind 100 is presented. The hunting blind 100 is useful for those that may need help in putting the hunting blind 100 in an ideal location of a tree. The hunting blind 100 is also useful to allow a hunter, in the hunting blind, to remain in the hunting blind when accessories are needed. The hunter would not leave the hunting blind 100 which may scare away to game the hunter is hoping to hunt. The hunting blind 100 is preferably seven (7) feet in height, but other heights are hereby contemplated including, but not limited to, eight (8) feet, five (5) feet, six and one-half (6.5) feet, etc.

The hunting blind 100 has a frame 102. The frame 102 is preferably a double braced frame. The frame 102 is preferably a light weight, sturdy material such as aluminum, but other materials are hereby contemplated such as, but not limited to, wood, poly-vinyl chloride (PVC), high-density poly-ethylene (HDPE), etc. The frame 102 of the hunting blind 102 may have a canopy 103 coupled to a top 101 of the frame 102. The canopy 103 is preferably made of a canvass material but other materials are hereby contemplated including, but not limited to, plastic, leather, etc.

The hunting blind 100 has a ball hitch 104, a winch 106, a hook 108, a switch 110 and a power source 112. The hook 108 of the hunting blind 100 is coupled to the winch 106 of the hunting blind using a cable 107. The winch 106 is configured to be interior of the hunting blind 100. The hook 108 is preferably a double eye slanted hook. The cable 107 is preferably a one-thousand (1000) pound cable, but other cables are hereby contemplated including, but not limited to, two-thousand (2000) pound, fifteen hundred (1500) pound, etc. The winch 106 is preferably a twelve volt (12v) self-locking winch, but other winches are hereby contemplated including, but not limited to, electric winch, mooring winch, etc.

The winch 106 is communicatively coupled to the power source 112 by a first electrical wire 109. The power source 112 is preferably a twelve-volt (12v) battery, but other power sources are further contemplated including, but not limited to, solar, rechargeable batteries, wind turbine, ac/dc converter, etc. The power source 112 being configured to be contained in a case 134. The case 134 is preferably a marine swinging battery case. The power source 112 has an indicator light 135 for displaying the charging status of the power source 112. The indicator light 135 is preferably a light emitting diode (LED) lamp, however other lamps are hereby contemplated, including, but not limited to, liquid crystal display (LCD), fluorescent, etc.

The winch 106 is further coupled to the switch 110. The switch 110 has an on/off actuator useful to control the power to the winch 106. When the switch 110 is actuated, the winch 106 is powered by the power source 112 and the cable 107 is retracted into the winch 106. The switch 110 is coupled to the power source 112 by a second electrical wire 111.

Once the hunting blind 100 is raised into the tree at a predetermined location, the hunting blind is anchored to the tree utilizing a tree anchor 114. The hunting blind 100 has a plurality of site windows 116. The number of the plurality of site windows 116 preferably being three (3). The site windows 116 are useful for having multiple views from the hunting blind 100 for shooting. The site windows 116 have a covering 117. The covering 117 is preferably a pull rope cover but may be other types of covers such as a slide cover, a hinged cover, etc.

A lamp 118 is coupled to the top 101 of the frame 102 of the hunting blind 100. The lamp 118 is preferably a light emitting diode (LED), but other types of lamps are hereby contemplated including, but not limited to, compact florescent lamp (CFL), fluorescent lamp, etc. The lamp 118 is powered by the power source 112. The lamp 118 is coupled to the power source 112 by the first electrical wire 109.

A charger 122 for a portable computing device is coupled to a first outside wall 121 of the frame 102. The charger 122 is preferably a universal serial bus—type C (USB-C) port, but other ports are hereby contemplated such as, but not limited to, USB-A, USB-B, etc. The charger 122 is coupled to the power source 112 by a third electrical wire 123. The portable computing device is preferably a cellular phone, but other computing devices are hereby considered including, but not limited to, tablet, laptop, kindle, etc.

The hunting blind 100 further has a commode 124. The commode 124 is preferably a self-contained toilet but other types of commodes are hereby contemplated including, but not limited to, camping flush toilet, curve portable toilet, etc. The commode 124 is preferably removable but commodes that are not portable are also contemplated. The commode 124 preferably can set bi-directionally, but single direction toilets are hereby contemplated. The commode 124 is useful to allow the hunter to use the facilities without leaving the hunting blind 100 potentially missing hunted game or scaring the game away.

The hunting blind 100 also has a heater/cooker 126. The heater/cooker 126 provides heat and a device to cook food in the hunting blind 100 for comfort of the hunter. The heater/cooker 126 is preferably powered by propane gas. A cooler 128 is further provided to allow for cold and/or cool food and beverage to be kept at a safe temperature. The cooler 128 is preferably insulated.

To allow the hunter to take weight off of their feet and have a more enjoyable and potentially better experience, a seat 130 is coupled to the first side 132 of the frame 102 and further coupled to a second side 131 of the frame 102.

The hunting blind 100 further has at least two wheels 136. The wheels 135 being couple to a bottom 137 of the hunting blind 100 for towing.

Moving now to FIG. 1B, a pistol/crossbow 200 for providing the initial cable 107 into a tree for lifting the hunting blind 100. The pistol/crossbow has a handle 202. The handle 202 provides a location for the hunter to safely and securely grip the pistol/crossbow 200 when in use.

The pistol/crossbow further has a barrel 204, a trigger 206, an open-faced reel 208 and a exit port 210. The barrel 204 is coupled to the handle 202. The barrel 204 is preferably hollow and can have the cable 107 threaded through the hollow portion of the barrel 204.

The cable 107 is removably coupled to the open-faced reel 208. The open-faced reel 208 allows for the cable 107 to be released when the trigger 206 is actuated. The trigger 206 is coupled to the open-faced reel 208. The trigger 206 is securely coupled to the handle 202 of the pistol/crossbow 200.

When the trigger 206 is actuated, the trigger 206 communicates mechanically with the open-faced reel 208 to release the cable 107. The cable 107 is released into the barrel 204 and is expelled at a high velocity through an open end 210 of the barrel 204.

Once the cable 107 has been “shot” into the tree at the desired predetermined location, the cable 107 is coupled to the hook 108 that is coupled to the winch 106. The winch 106 is then actuated by the switch 110 to raise the hunting blind 100 into the tree such that the hunter can use it to find and hunt desired game.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A hunting blind for providing comfort to a hunter, the blind comprising:
a frame, the frame being for defining the outline of the blind;
a winch, the winch coupled to a cable and a hook;
the cable being coupled to a tree and the hook;
a power source, the power source for powering the winch; and
a switch, the switch communicative coupled to the battery, wherein the battery being communicative coupled to the winch, and wherein when the switch is actuated the winch retracts the cable thereby raising the blind into the tree.

2. The blind of claim 1, wherein the power source being a battery.

3. The blind of claim 1, wherein the cable being capable of holding one-thousand (1000) pounds.

4. The blind of claim 1, the hook being a double-eye slanted hook.

5. The blind of claim 1, the blind further comprising:
a charger, the charger for charging computing devices; and
wherein the charger being coupled to the power source.

6. The blind of claim 5, wherein the charger being a universal serial bus type C (USB-C) port.

7. The blind of claim 1, the blind further comprising
a lamp, the lamp for lighting the blind; and
the lamp communicative coupled to the power source by an electrical wire.

8. The blind of claim 7, wherein the lamp being a light emitting diode (LED) lamp.

9. The blind of claim 1, the blind further comprising:
a plurality of windows, the windows for shooting at game; and
a covering, wherein the covering being controlled by a pull rope.

10. The blind of claim 9, wherein the plurality of windows is three (3).

11. The blind of claim 1, the blind further comprising:
a commode, wherein the commode being for providing comfort for the hunter.

12. The blind of claim 11, wherein the commode being removeable.

13. The blind of claim 1, wherein the blind having a height of seven (7) feet.

14. The blind of claim 1, the blind further comprising:
a heater/cooker, wherein the heater/cooker being for providing heat to the blind and wherein the heater/cooker being for cooking food.

15. The blind of claim 14, wherein the heater/cooker being powered by propane gas.

16. The blind of claim 1, the blind further comprising:
a cooler, wherein the cooler being for keeping food and beverages cold.

17. The blind of claim 1, wherein the blind further comprising:
a seat, wherein the seat being for the hunter to sit.

18. The blind of claim 1, the blind further comprising:
a pistol/crossbow, wherein the pistol/crossbow being for expelling a cable into the tree.

19. The blind of claim 18, wherein the pistol/crossbow further comprising:
A handle, the handle being for safety and control of the pistol/cross bow;
A trigger, the trigger being coupled to the handle and wherein the trigger being coupled to an open-ended reel;
the cable being removably coupled to the open-ended reel; and
a barrel, wherein the barrel for directing the cable to a desired location a when the trigger is actuated.

20. The blind of claim 18, wherein when the cable being directed into the tree from the pistol/crossbow, the cable being coupled to the hook and wherein the switch is actuated wherein the winch retracts the cable and wherein the blind is raised into the tree at the predetermined location.
